(19) United States
(12) Patent Application Publication
(10) Pub. No.: US 2013/0269818 A1
(43) Pub. Date: Oct. 17, 2013

(54) CONDUIT FOR CONVEYING FLOWABLE MATERIAL

(71) Applicant: Hitoya Kodama, Elk Grove Village, IL (US)

(72) Inventor: Hitoya Kodama, Elk Grove Village, IL (US)

(21) Appl. No.: 13/447,663

(22) Filed: Apr. 16, 2012

(51) Int. Cl. F16L 11/127; F16L 11/11; F16L 55/00

(52) U.S. Cl. 138/103; 138/122; 138/124

(57) ABSTRACT

A conduit for conveying a flowable material. The conduit has an elongate body made from a non-metallic material. The body has a lengthwise central axis, spaced ends, an inside surface bounding a passageway for communication of a flowable material between the elongate body ends, and an outside. At least one grounding component is embedded in the body to dissipate static electricity generated by conveyance of flowable material through the passageway.

### BACKGROUND OF THE INVENTION

1. Field of the Invention

This invention relates to conduits through which flowable material is conveyed and, more particularly, to a conduit constructed to dissipate static electricity generated by the material flow.

2. Background Art

Conduits made from non-metallic material are utilized in many different environments to convey flowable material between spaced locations. In one exemplary application, such conduits are used to convey food product from a bulk supply thereof to a point of use, which may be a staging location at which the material may be processed and/or packaged, or from where the material may be transported to yet another location. Examples of this type of product are grains, beans, product in powdered form, etc. Designers of these conduits focus upon a number of objectives, which often compete with each other.

First and foremost, the conduits generally must be made with a construction that is flexible, yet which is durable enough to withstand the rigors of a particular environment and application. These conduits are often required to be bent to fairly tight radiuses to work within the confines of the operating environment. Further, they are often dragged over hard and abrasive surfaces and worn away as they are maneuvered during setup and in use. Repeated bending, and expansion and contraction, tend to fatigue the material making up the conduits to the point that they are prone to failure, particularly as they diminish in thickness as a result of abrasive wear. This problem is aggravated by the fact that the conduits may be required to perform in environmental conditions with temperatures ranging from well below freezing to temperatures exceeding 100° F.

While durability is a clear design focus, these conduits are only practically usable if they are light enough to be easily hand maneuvered as they are set up, operated and disassembled for storage. In the past, a balance has been struck between product weight and durability, given that increasing wall thickness, to improve durability and lengthen product life, normally causes an appreciable weight increase, even with the current availability of strong, lightweight materials.

One very significant problem with these conduits is that they will commonly be made with non-metallic material that builds up static electricity resulting from frictional forces as flowable material advances against the conduit surfaces. This may result in material hang-up that reduces flow volume and potentially even a blockage.

Further, the electrical charge may build to a level that those handling the conduits may experience an electrical shock. In a worst case, the voltage buildups may ignite flammable materials or vapors or cause spontaneous combustion of particulate that becomes entrained in the air volume with the conduit passageways. The possibility of explosions during transportation of flowable materials is a problem that many industries contend with and that is known to cause injuries and even death.

Another problem that has been contended with using this type of conduit is that it may be difficult to determine whether, or what amount of, material is actually being conveyed through a conduit when it is not possible to observe discharge therefrom.

Certain of the above design issues become particularly challenging in environments where food-grade materials are transported.

### SUMMARY OF THE INVENTION

In one form, the invention is directed to a conduit for conveying a flowable material. The conduit has an elongate body made from a non-metallic material. The elongate body has a lengthwise central axis, spaced ends, an inside surface bounding a passageway for communication of a flowable material between the elongate body ends, and an outside. At least one grounding component is embedded in the body to dissipate static electricity generated by conveyance of flowable material through the passageway.

In one form, the at least one grounding component is spirally wrapped around the central axis.

In one form, the body has a generally cylindrical outside surface portion and a support for the at least grounding component. The support projects radially outwardly from the cylindrical outside surface portion.

In one form, the support extends spirally around the central axis.

The at least one grounding component may be embedded in the support.

In one form, the at least one grounding component is made from at least one of stainless steel and copper.

The non-metallic material on the body may be made from at feast one of polyurethane, urethane, and PVC.

The support may be made from at least one of PVC, urethane, and HDPE.

In one form, the support defines the radially outermost dimension of the conduit.

The body may be made with multiple plies of non-metallic material.

The non-metallic material of the body may be reinforced with a layer of woven material.

In one form, the woven material is made from polyester yarn.

In one form, the at least one grounding component extends one of: (a) between conductive parts spaced from each other lengthwise relative to the conduit; and (b) to a grounding part.

In one form, the conduit has spaced first and second ends and the conductive parts are at the spaced ends of the conduit. The at least one grounding component extends between, and is electrically connected to, the conductive parts at the conduit ends.

In one form, the at least one of the conductive parts is a coupling element to operatively join the first conduit end to another part to allow one of: (a) delivery of flowable material to the passageway through the first conduit end; and (b) discharge of flowable material from the passageway through the first conduit end.

The non-metallic material may be transparent to allow viewing of flowable material in the passageway.

In one form, the passageway has a diameter of from 2 to 8 inches.

In one form, the support has turns that are spaced axially from each other no more than 2 inches.

The at least one grounding component may be fully surrounded by the support.

A static dissipating agent may be disposed in the non-metallic material.

In one form, the body has a substantially uniform thickness between the spaced ends.

In one form, the body has a main portion with a substantially uniform thickness between the spaced ends and the support is separately formed from, and bonded to, the main body portion.

The main body portion and support may each be made from a non-metallic material. The non-metallic material of the support is more rigid than the non-metallic material of the main body portion.

In one form, the at least one grounding component is a conductive element that is made from at least one of carbon, nanotube metal chips, metal yarn, and a static dissipating agent.

### BRIEF DESCRIPTION OF THE DRAWINGS

FIG. 1 is a schematic representation of a system for conveying flowable material including a conduit, according to the invention, incorporated therein;

FIG. 2 is a schematic representation of the conduit in FIG. 1 and showing further details thereof;

FIG. 3 is a schematic representation of one system in which the inventive conduit is incorporated;

FIG. 4 is a view as in FIG. 3 of an alternative system;

FIGS. 5-7 schematically and sequentially depict the generation of a static electrical charge with a conventional conduit;

FIG. 8 is a fragmentary, perspective view of a conduit according to the present invention;

FIG. 9 is a cross-sectional view of the conduit taken along line 9-9 of FIG. 8;

FIG. 10 is a fragmentary view of a portion of the conduit in FIGS. 8 and 9 with a conductive component embedded therein;

FIGS. 11-13 are schematic representations of the inventive conduit showing dissipation of a static electrical charge, with FIG. 11 showing the conduit before charging and FIGS. 12 and 13 respectively showing external and internal charge dissipation;

FIG. 14 is a view as in FIG. 10 wherein the conductive component is embedded in another part of the inventive conduit;

FIG. 15 is a view as in FIG. 8 of a modified form of conduit, according to the invention;

FIG. 16 is a cross-sectional view of a part of a further modified form of conduit made from multiple plies of non-metallic material; and

FIG. 17 is a fragmentary, cross-sectional view of a still further modified form of conduit.

### DETAILED DESCRIPTION OF THE PREFERRED EMBODIMENT

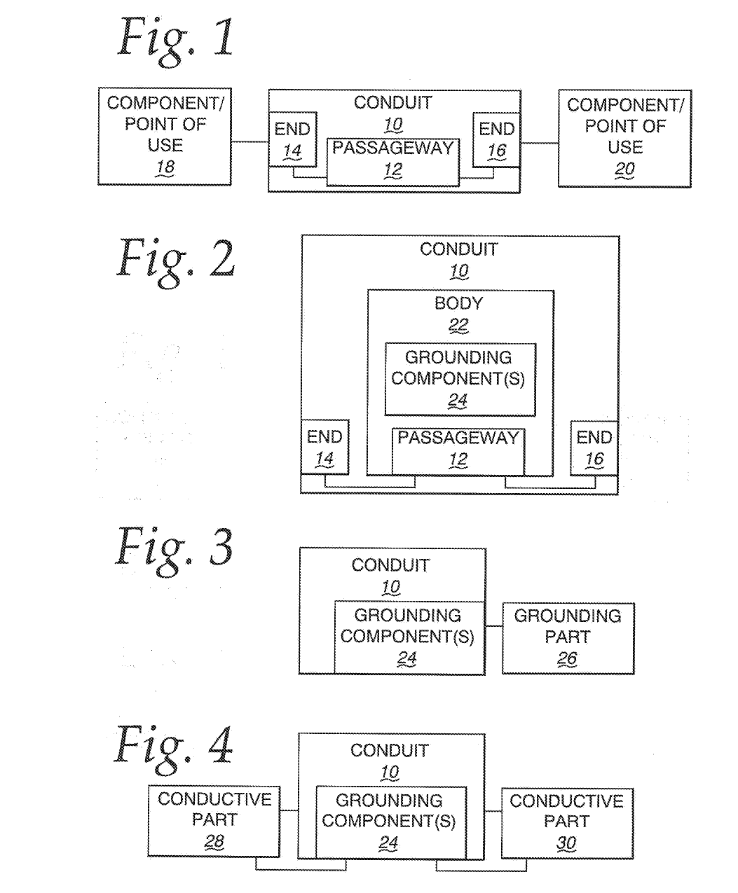

FIG. 1 is a schematic representation of a conduit 10, according to the present invention. For purposes of simplification, the conduit 10 will be considered to be one piece, whereas the conduit 10 could be made up of two or more joined lengths. The conduit 10 has a passageway 12 for communication of flowable material between opposite ends 14,16, with one of the ends 14,16 defining an inlet to the passageway 12 and the other of the ends 14,16 defining an outlet therefrom.

The ends 14,16 are respectively in communication with a component/point of use 18,20. Conveyance of flowable material to/from the ends 14,16 may be affected under pressure or through the generation of vacuum. The invention contemplates use of the inventive conduit in virtually any environment where flowable material is conveyed. Some examples of use are set forth below.

In one form, the component/point of use 18 is a bulk supply of flowable material that is directed into the passageway 12 through the end 14. The flowable material is conveyed through the passageway 12 to the end 16 and is discharged to the component/point of use 20. The component/point of use 20 may be a joined end of a separate conduit. Alternatively, the component/point of use 20 may be a staging or collection location at which the flowable material is processed, or from which it is transported to another location. The component/point of use 18 might alternatively be a separate conduit or some other means for delivering flowable material to the passageway 12 through the conduit end 14.

According to the invention, as shown also schematically in FIG. 2, the conduit has an elongate body 22 that defines the passageway 12 that communicates between the ends 14,16. At least one grounding component 24 is embedded in the body 22 to dissipate static electricity generated by conveyance of flowable material through the passageway 12.

As shown schematically in FIG. 3, the grounding component(s) 24 and the conduit 10 may be electrically connected to a grounding part 26. The nature of the grounding part 26 is not critical and may take any form conventionally utilized as a “ground”. As just one example, the grounding part 26 may be a movable piece of equipment, such as a vehicle. Alternatively, the ground part 26 may be permanently located.

Alternatively, as shown schematically in FIG. 4, the grounding component(s) 24 and the conduit 10 may be electrically connected between separate conductive parts 28,30 on the conduit 10. The conductive parts 28,30 may be in turn electrically connected to another component, which is grounded. As one example, the conductive part 28 may be an element to couple to another conduit. The conduit part 30 may be a grounded part or another coupling element which is grounded or electrically coupled to still a further coupling part.

Generally, the invention contemplates that the grounding components 24 define an electrical path directly to ground from the conduit 10 or establish a conductive path through one or more other conductive components which may be grounded up or downstream.

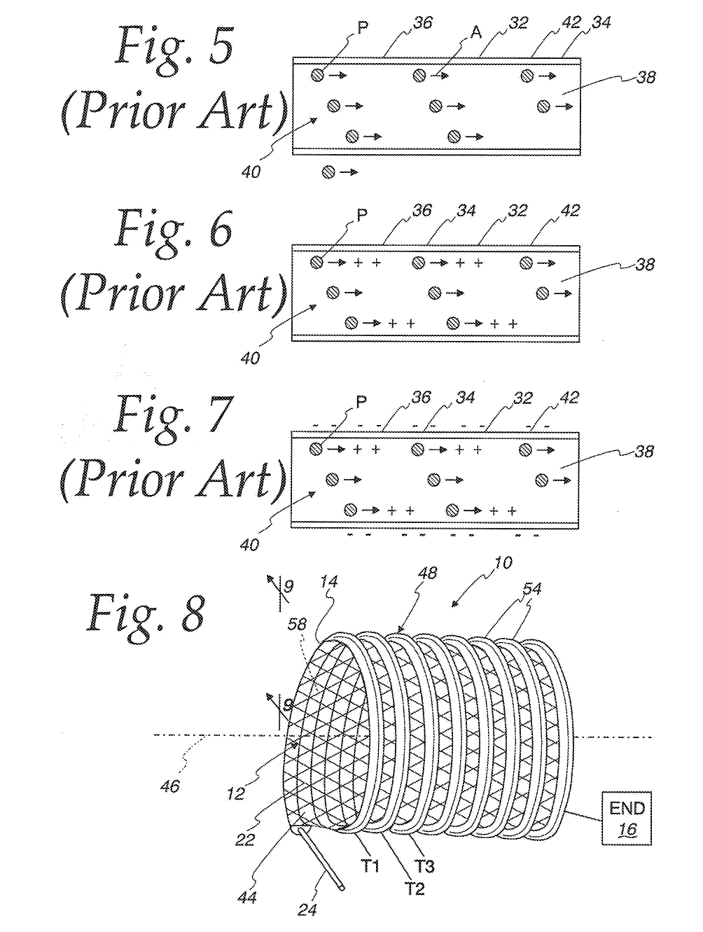

The need for grounding with conduits made from non-metallic materials is explained below with respect to FIGS. 5-7. The description will be with respect to flowable material, as in the form of a particulate. A conduit 32 has a body 34 with a wall 36 having an inside surface 38 bounding a passageway 40. Individual particles P moves from left to right, as indicated by the arrows A. Certain of the particles P move along and against the inside surface 38 and by reason of frictional forces create static “+” or “−” electrical charges on the wall 36, as indicated in FIGS. 6 and 7. The charges at the inside wall surface 38 create an opposite charge on the outside wall surface 42, as indicated in FIG. 7. As the particles continue to travel, the static charge may build, in some applications to in excess of 40,000 volts. As a result of this buildup, when a person contacts the outside wall surface 42, he/she may experience an electrical shock.

With any electrical discharge that produces an arc/spark, there is a risk of an ignition/explosion of materials within or in the vicinity of the conduit 32. This condition is particularly dangerous with flowable material wherein certain of the particulate is light in weight and entrained in the air moving within and around the conduit 32. Spontaneous combustion may occur. These conditions typically exist when handling powders, food products such as beans, grains, etc.

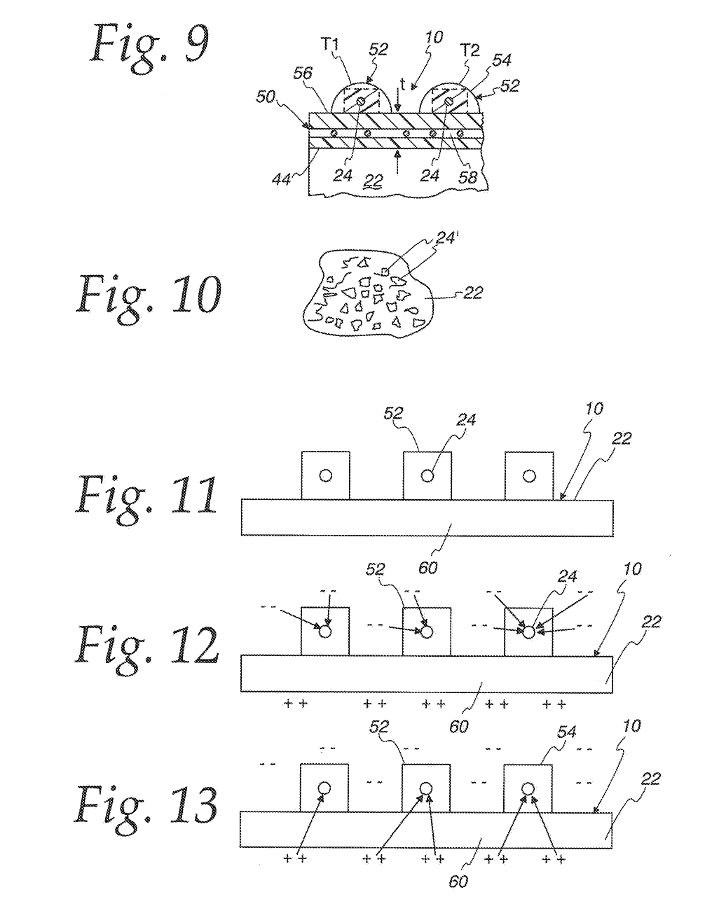

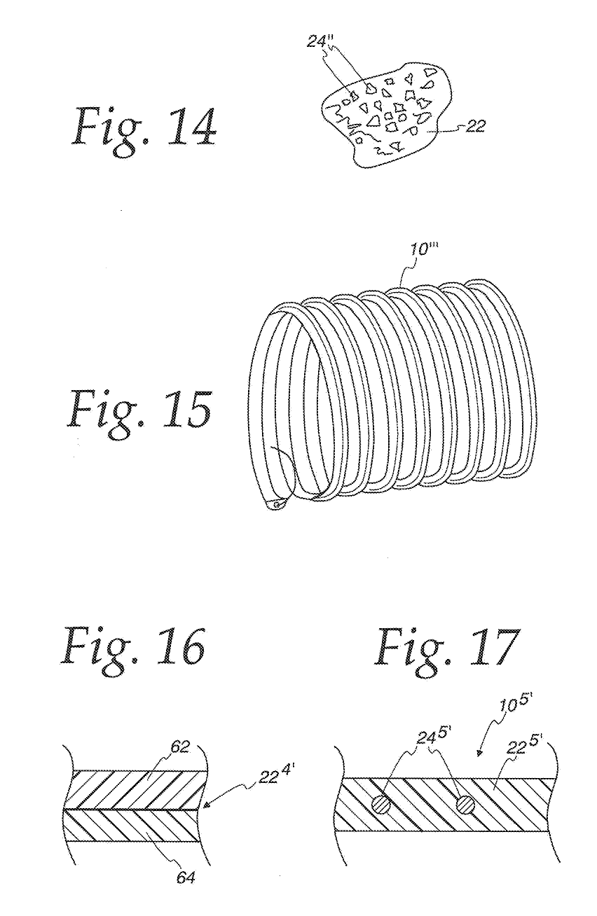

In FIGS. 8 and 9, one specific form of the inventive conduit 10 is depicted. The body 22 has an inside surface 44 that bounds the passageway 12 that communicates flowable material between the ends 14,16. The body 22 has a lengthwise, central axis 46. The outside 48 of the body 22 typically remains exposed as the conduit 10 is used.

Typically, the non-metallic material that makes up the body 22 is a flexible plastic, as commonly used for conduits of this type. Examples of materials contemplated are polyurethane, urethane, PVC, etc. While these materials are preferred, they should not be viewed as limiting.

In this embodiment, the body 22 consists of a main portion 50 and a support 52 that are joined to produce a unitary body structure. The main body portion 50 has a substantially uniform thickness t between the ends 14,16.

The support 52 is in the form of a bead 54 with a generally square cross-sectional configuration, as seen in dotted lines in FIG. 9. The precise cross-sectional configuration is not critical to the present invention and can vary significantly therefrom. A preferred cross-sectional shape is a portion of a sphere, as shown in FIGS. 8 and 9. The support 52 may be otherwise shaped so that the exposed portion thereof is convexly curved. The bead 54 is wrapped spirally around the main body portion 50 to produce regularly spaced turns (three shown at T1,T2,T3).

Within the bead 54, the grounding component 24 is embedded so that it follows the same spiral pattern as the bead 54.

In one preferred form, the support material is a more rigid material than that making up the main body portion 50. As an example, the support material may be at least one of PVC, urethane, HDPE, etc.

The grounding component 24 is shown in the form of a wire that conducts electricity. Preferably, the grounding component 24 is a metal component made as from stainless steel, copper, etc. As depicted, the grounding component 24 is embedded in the support 52. In one preferred form, the support material fully surrounds the grounding component 24, though this is not a requirement.

In one form, the main body portion 50 and support 52 are separately formed. The support 52, with the embedded grounding component 24, is spirally wrapped around the axis 46, potentially in a partially cured state. With the material of the main body portion 50 and support 52 fully cured, the main body portion 50 and support 52 become positively united.

The completed conduit 10 has a generally cylindrical outside surface portion 56 between adjacent turns, with the support 52 projecting radially outwardly therefrom. The support 52 preferably projects radially a distance equal to or greater than the thickness t of the main body portion 50. With this arrangement, the support 52 defines the radially outermost dimension of the conduit 10. Preferably, the axial spacing between the turns is close enough so that the support material will effectively block contact of the outside surface portion 56 with a supporting surface for the conduit 10, thereby to avoid abrasion. The more rigid material defining the support 52 is more resistant to wear while at the same time a spiral arrangement allows the main body portion 50 to remain flexible. This design permits a significant weight reduction, compared to prior art conduits, without comprising performance. The spacing of the turns T1,T2,T3 is preferably not greater than 2 inches and generally substantially less than 2 inches to achieve this end.

In this embodiment, a woven layer 58 is formed within the main body portion 50 and performs a reinforcing function. As one example, the layer 58 may be made from woven polyester yarn.

The non-metallic material making up the main body portion 50 may be made to be transparent to allow viewing of flowable material within the passageway 12.

As an alternative to the use of the grounding component 24, or in addition thereto, a grounding component 24′ may be embedded in the material defining the support 22, as shown in FIG. 10. As depicted, the grounding component 24′ is a conductive material that may be made from at least one of carbon, nanotube metal chips, metal yarn, and a static dissipating agent. These are exemplary in nature and should not be viewed as limiting. These compositions are commercially available and could be incorporated/embedded to effect the dissipation of static electricity or assist the dissipation thereof in conjunction with other grounding components, such as the grounding component 24.

With the inventive structure, the static charge is dissipated, as shown schematically in FIGS. 11-13, with the basic components—the conduit 10, body 22, grounding component 24, and support 52—depicted.

In FIG. 11, the conduit 10 is shown without any static charge buildup. In FIG. 12, an external positive charge is shown dissipating by passing through the support 52 and to the grounding component 24. In FIG. 13, the positive charge inside the passageway is shown dissipating by passing through the wall 60 of the conduit 10 to the grounding component 24.

To enhance the external discharge, as shown in FIG. 12, the aforementioned grounding components 24′ can additionally be utilized in the support.

To enhance the internal discharge, as shown in FIG. 13, a conductive grounding component 24″ may be incorporated into the non-metallic wall material. The grounding component 24″ may be in form of a dissipating agent or other embedded component, such as described above for the support 52. Dissipating agents are known in this industry and will tend to bleed through the wall 60 to generate moisture that itself effectively dissipates any built up electrical charge.

In typical applications, the passageway 12 will have a diameter on the order of 2 to 8 inches. A typical outside diameter where the same range is preferably from 2.5 to 8.79 inches. The construction is such that the preferred minimum bending radius is 6 to 18 inches within the same range. These are design guidelines but not design requirements.

In FIG. 15, a further embodiment of the inventive conduit is shown at 10′″. The conduit 10′″ has the same general construction as the conduit 10, with the exception that the reinforcing layer 58 is omitted.

A further variation is shown in FIG. 16 wherein the body 22^{4′} is made from separate, joined plies 62,64 of non-metallic material. The plies 62,64 can be made with or without conductive additives functioning as the aforementioned conductive components.

In FIG. 17, a further modification is shown wherein a conduit 10^{5′} has a grounding component 24^{5′} embedded directly in that portion of the body 22^{5′} corresponding to the main portion 50, described above. In this form, the support 52 is eliminated.

Optionally, additionally or alternatively, a dissipating agent or other electrical charge dissipating component can be incorporated into the nonconductive material.

One skilled in the art would be able to readily devise the structure for electrically connecting the conduits 10,10′″ to their respective component/part to facilitate the grounding. Thus, it is unnecessary to explain in detail how such interconnection occurs.

The foregoing disclosure of specific embodiments is intended to be illustrative of the broad concepts comprehended by the invention.

1. A conduit for conveying a flowable material, the conduit comprising:
an elongate body comprising a non-metallic material and having a lengthwise central axis, spaced ends, an inside surface bounding a passageway for communication of a flowable material between the elongate body ends, and an outside; and
at least one elongate grounding component embedded in the body and extending around the central axis to dissipate static electricity generated by conveyance of flowable material through the passageway.

2. The conduit for conveying a flowable material according to claim 1 wherein the at least one grounding component is spirally wrapped around the central axis.

3. The conduit for conveying a flowable material according to claim 1 wherein the body has a generally cylindrical outside surface portion and comprises a support for the at least one grounding component, the support projecting radially outwardly from the cylindrical outside surface portion.

4. The conduit for conveying a flowable material according to claim 3 wherein the support extends spirally around the central axis.

5. The conduit for conveying a flowable material according to claim 4 wherein the at least one grounding component is embedded in the support.

6. The conduit for conveying a flowable material according to claim 2 wherein the at least one grounding component comprises at least one of stainless steel and copper.

7. The conduit for conveying a flowable material according to claim 6 wherein the non-metallic material on the body comprises at least one of polyurethane, urethane and PVC.

8. The conduit for conveying a flowable material according to claim 7 wherein the support comprises at least one of PVC, urethane and HDPE material.

9. The conduit for conveying a flowable material according to claim 8 wherein the support defines a radially outermost dimension of the conduit.

10. The conduit for conveying a flowable material according to claim 2 wherein the body comprises multiple plies of non-metallic material.

11. The conduit for conveying a flowable material according to claim 1 wherein the non-metallic material is reinforced with a layer of woven material.

12. The conduit for conveying a flowable material according to claim 11 wherein the layer of woven material comprises polyester yarn and the non-metallic material comprises at least one of polyurethane, urethane and PVC.

13. The conduit for conveying a flowable material according to claim 1 wherein the at least one grounding component extends one of: (a) between conductive parts spaced from each other lengthwise relative to the conduit; and (b) to a grounding part.

14. The conduit for conveying a flowable material according to claim 13 wherein the conduit has spaced first and second ends, the conductive parts are at the spaced ends of the conduit and the at least one grounding component extends between and is electrically connected to the conductive parts at the conduit ends.

15. The conduit for conveying a flowable material according to claim 14 wherein at least one of the conductive parts is a coupling element to operatively join the first conduit end to another part to allow one of: (a) delivery of flowable material to the passageway through the first conduit end; and (b) discharge of flowable material from the passageway through the first conduit end.

16. The conduit for conveying a flowable material according to claim 1 wherein the non-metallic material is transparent to allow viewing through the non-metallic material of flowable material in the passageway.

17. The conduit for conveying a flowable material according to claim 1 wherein the passageway has a diameter of from 2-8 inches.

18. The conduit for conveying a flowable material according to claim 4 wherein the support: has turns that are spaced axially from each other no greater than 2 inches.

19. The conduit for conveying a flowable material according to claim 3 wherein the at least one grounding component is fully surrounded by the support.

20. The conduit for conveying a flowable material according to claim 1 wherein the non-metallic material has a static dissipating agent disposed therein.

21. The conduit for conveying a flowable material according to claim 1 wherein the body has a substantially uniform thickness between the spaced ends.

22. The conduit for conveying a flowable material according to claim 3 wherein the body comprises a main portion with a substantially uniform thickness between the spaced ends and the support is separately formed from and bonded to the main body portion.

23. The conduit for conveying a flowable material according to claim 22 wherein the main body portion and support are each made from a non-metallic material, the non-metallic material of the support being more rigid than the non-metallic material of the main body portion.

24. The conduit for conveying a flowable material according to claim 1 wherein the at least one grounding component comprises a conductive material that made from at least one of carbon, nanotube metal clips, metal year, and a static dissipating agent.

25. The conduit for conveying a flowable material according to claim 3 wherein the at least one grounding component comprises a conductive material that made from at least one of carbon, nanotube metal clips, metal year, and a static dissipating agent.
